(19) United States
(12) Patent Application Publication
(10) Pub. No.: US 2026/0022918 A1
(43) Pub. Date: Jan. 22, 2026

(54) TARGET PAPER WITH DOUBLE TARGET PATTERN SURFACES

(71) Applicant: WODE GLOBAL (QINGDAO) OUTDOOR CO., LTD., Qingdao City (CN)

(72) Inventor: Yingchun ZHAO, Qingdao City (CN)

(21) Appl. No.: 19/187,941

(22) Filed: Apr. 23, 2025

Related U.S. Application Data
(63) Continuation of application No. 19/031,907, filed on Jan. 18, 2025.

(30) Foreign Application Priority Data
Jul. 22, 2024 (CN) 202421733070.3

(51) Int. Cl. F41J 1/00; B32B 7/06; B32B 7/12; B32B 29/00

(52) U.S. Cl. CPC F41J 1/00; B32B 7/06; B32B 7/12; B32B 29/005; B32B 2307/4023; B32B 2307/748; B32B 2554/00

(57) ABSTRACT

A target paper with double target pattern surfaces, including: a release paper with one surface having a release layer, and an adhesive paper stuck onto the release layer; wherein a surface of the adhesive paper opposite to the release paper and either of two surfaces of the release paper in a thickness direction are provided with a target pattern respectively. For the target paper with an adhesive paper structure according to the present disclosure, the release paper can be fully utilized.

### CROSS-REFERENCE TO RELATED APPLICATIONS

This application is a continuation of U.S. application Ser. No. 19/031,907, filed on Jan. 18, 2025, which claims the priority of Chinese patent application No. 202421733070.3, filed on Jul. 22, 2024, the disclosures of which are incorporated herein by reference in their entireties.

### TECHNICAL FIELD

The present disclosure relates to the field of target papers, and in particular, to a target paper with double target pattern surfaces.

### BACKGROUND

In the prior art, for a target paper with an adhesive paper structure, generally, an adhesive paper with a target pattern is torn from a release paper and stuck to a target, such that a user can shoot the target. From the moment when the adhesive paper is torn from the release paper, the action of the release paper, i.e., attachment for the adhesive paper, is completed, and the release paper can be discarded at this point. However, such a way of processing the release paper in the prior art is wasteful, and cannot make full use of the release paper.

Therefore, it is urgent to realize full utilization of the release paper in the target paper with the adhesive paper structure.

### SUMMARY

An object of the present disclosure is to provide a target paper with double target pattern surfaces, so as to make full use of a release paper in a target paper with an adhesive paper structure.

In order to achieve the above object, the present disclosure provides the following technical solution.

There is provided a target paper with double target pattern surfaces, including:
a release paper with one surface having a release layer; and
an adhesive paper stuck onto the release layer;
wherein a surface of the adhesive paper opposite to the release paper and either of two surfaces of the release paper in a thickness direction are provided with a target pattern respectively.

In some embodiments of the present application, the release paper includes a base paper layer, and the release layer is provided on a surface of the base paper layer.

In some embodiments of the present application, a surface of the base paper layer not provided with the release layer is provided with the target pattern.

In some embodiments of the present application, a surface of the base paper layer provided with the release layer is provided with the target pattern.

In some embodiments of the present application, the release layer is a transparent layer to reveal the target pattern provided on the base paper layer.

In some embodiments of the present application, the release layer is a colored layer to constitute the target pattern.

In some embodiments of the present application, the target pattern each includes at least two chromatic zones, and the chromatic zones have a same color type and different chrominances.

In some embodiments of the present application, the target paper has a target center, and the target pattern has a color chrominance gradually darkening or gradually lightening in a direction away from the target center.

In some embodiments of the present application, various regions of the respective target pattern have different printing densities of pigment dots.

In some embodiments of the present application, the target paper has at least two adhesive papers, wherein one of the adhesive papers serves as a main target sticker, the other adhesive papers serve as auxiliary target stickers, and at least one of the auxiliary target stickers is provided with the target pattern.

In some embodiments of the present application, the target pattern has a main target center.

In some embodiments of the present application, the target pattern further includes a plurality of auxiliary target centers, and the plurality of auxiliary target centers are arranged around the main target center.

Further fields of application will become apparent from the description of the present disclosure provided herein.

The description and specific examples in this summary are intended for purposes of illustration only and are not intended to limit the scope of the present disclosure.

Compared with the prior art, the technical solution provided in the present disclosure has the following beneficial effects:

For the target paper with the adhesive paper structure according to the present disclosure, the release paper can be fully used; more specifically, after the adhesive paper with the target pattern on the release paper is torn off, the release paper is also provided with the target pattern for the user to shoot; that is, for one target paper set, shooting is not limited to one target surface located on the adhesive paper.

### BRIEF DESCRIPTION OF THE DRAWINGS

To describe the technical solution according to the embodiments of the present application more clearly, the following briefly describes the accompanying drawings required for the description of the embodiments. Apparently, the accompanying drawings in the following description show merely some of the embodiments of the present application, and a person of skill in the art may still derive other drawings from these accompanying drawings without creative efforts.

FIG. 1 is a schematic diagram of a layered structure of a target paper according to a first embodiment of the present application;

FIG. 2 is a schematic diagram of a target pattern of a target paper according to a second embodiment of the present application;

FIG. 3 is a schematic diagram of chromatic zones of a target paper according to a third embodiment of the present application;

FIG. 4 is a schematic diagram of chromatic zones of a target paper according to a fourth embodiment of the present application;

FIG. 5 is a schematic diagram of chromatic zones of a target paper according to a fifth embodiment of the present application;

FIG. 6 is a schematic diagram of chromatic zones of a target paper according to a sixth embodiment of the present application;

FIG. 7 is a schematic diagram of a target pattern of a target paper according to a seventh embodiment of the present application; and

FIG. 8 is a schematic diagram of a target pattern of a target paper according to an eighth embodiment of the present application.

The main reference numerals in the accompanying drawings of the specification of the present disclosure are as follows:
1—release paper; 11—release layer; 12—base paper layer;
2—adhesive paper;
31—main target center; 32—auxiliary target center;
4—chromatic zone.

### DETAILED DESCRIPTION

The technical solution according to the embodiments of the present application will be clearly and completely described below, and apparently, the described embodiments are not all but only a part of the embodiments of the present application. All other embodiments obtained by a person of skill in the art based on the embodiments of the application without creative efforts shall fall within the protection scope of the present application. It should be understood that the specific embodiments described herein are merely for illustrating and explaining the application and are not intended to limit the present disclosure.

Any specific numerical value disclosed herein (including endpoints of numerical range(s)) is not limited to the precise value of that numerical value, and is to be understood to also encompass values close to the precise value, for example, all possible numerical values within ±5% of the precise value. For the disclosed numerical ranges, endpoint values of the ranges, the endpoint values and specific point values within the respective ranges, and the specific point values can be combined at random to obtain one or more new numerical ranges, and such new numerical ranges should also be considered to be specifically disclosed herein.

The terminology used in the present disclosure is for the purpose of describing particular exemplary embodiments only and is not intended to be limiting. As used in the present disclosure, the singular forms “a”, “an” and “the” may be intended to include the plural forms as well, unless the context clearly indicates otherwise. The terms “comprising”, “including” and “having” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “including” should be understood as a non-limiting term used to describe and claim various embodiments described in the present disclosure, in certain aspects, the term may instead be understood as a more limiting and restricting term, such as “consisting of . . . ” or “consisting essentially of . . . ”. Thus, for any given embodiment for reciting a composition, material, component, element, feature, integer, operation, and/or process step, the present disclosure also particularly includes embodiments which consist of, or consist essentially of, such recited composition, material, component, element, feature, integer, operation, and/or process step. In the case of “consisting of . . . ”, any additional composition, material, component, element, feature, integer, operation, and/or process step are excluded from alternate embodiments, and in the case of “consisting essentially of . . . ”, any additional composition, material, component, element, feature, integer, operation, and/or process step substantially affecting the basic and novel characteristics are excluded from such embodiments, but any composition, material, component, element, feature, integer, operation, and/or process step which do not substantially affect the basic and novel characteristics may be included in the embodiments.

Any method step, process, and operation described in the present disclosure should not be construed as necessarily requiring their implementation in the particular order discussed or illustrated, unless specifically determined. It is also to be understood that additional or alternative steps may be used, unless stated otherwise.

In the present disclosure, any matter or item which is not mentioned is directly applicable to those known in the art without any change except what is explicitly stated. Moreover, any embodiment described in the present disclosure may be freely combined with one or more other embodiments described in the present disclosure, and the resulting technical solutions or concepts are considered as part of the original disclosure or original description of the present application, and should not be considered as new content not disclosed or contemplated by the present disclosure unless such a combination is considered by those skilled in the art to be clearly unreasonable.

Unless stated otherwise, the terms used herein have the same meaning as commonly understood by those skilled in the art, and if a term is defined herein and its definition is different from the definition commonly understood in the art, the definition herein prevails.

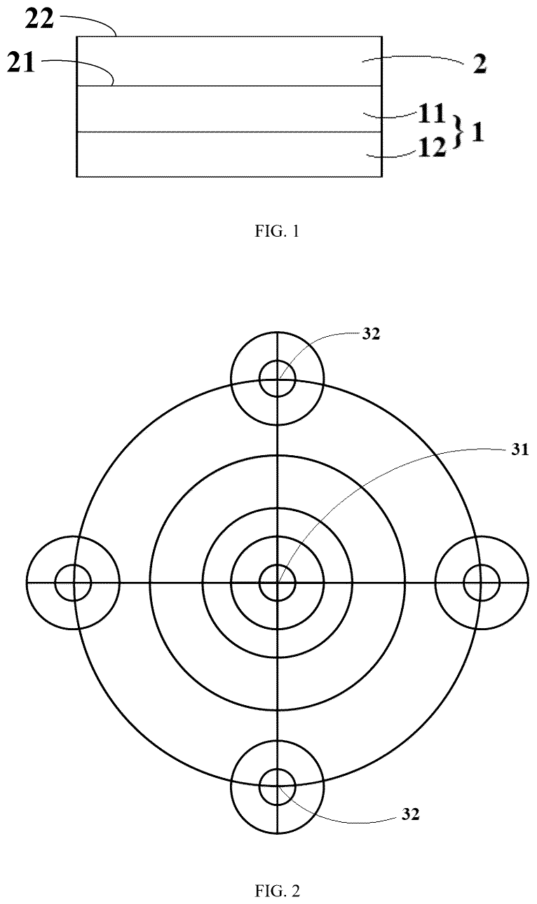

Referring to FIGS. 1, 7 and 8, in some embodiments of the present application, a target paper with double target pattern surfaces includes: a release paper 1 with one surface having a release layer 11; and an adhesive paper 2 stuck onto the release layer 11; wherein a surface of the adhesive paper 2 opposite to the release paper 1 and either of two surfaces of the release paper 1 in a thickness direction are provided with a target pattern respectively.

In the prior art, for a target paper with an adhesive paper structure, generally, an adhesive paper with a target pattern is torn from a release paper and stuck to a target, such that a user can shoot the target; from the moment when the adhesive paper is torn from the release paper, the action of the release paper, i.e., attachment for the adhesive paper, is completed, and the release paper can be discarded at this point; however, such a way of processing the release paper in the prior art is wasteful, and cannot make full use of the release paper. Therefore, the present disclosure provides the above-described target paper with double target pattern surfaces.

For the target paper with the adhesive paper structure according to the present disclosure, the release paper can be fully used; more specifically, after the adhesive paper with the target pattern on the release paper is torn off, the release paper is also provided with the target pattern for the user to shoot; that is, for one target paper set, shooting is not limited to one target surface located on the adhesive paper.

Referring to FIGS. 1, 7 and 8, specifically, the user tears the adhesive paper 2 with target pattern from the release paper 1 and sticks the adhesive paper 2 to the target for shooting, and meanwhile, the user can also choose to hang or stick the release paper 1 with target pattern on the target to shoot the release paper I with target pattern; that is, for the target paper with double target pattern surfaces according to the present disclosure, the release paper which is otherwise discarded after the adhesive paper is torn off is reused, such that the release paper can also serve as a target after the adhesive paper is torn off, thereby realizing full utilization of the release paper.

It should be noted that “either of two surfaces of the release paper 1 in a thickness direction is provided with a target pattern” means that: at least one of the two surfaces of the release paper 1 is provided with the target pattern; specifically, as optional possibilities, a front surface of the release paper 1 is provided with the target pattern, or a back surface of the release paper 1 is provided with the target pattern, or both the front surface and the back surface of the release paper 1 are provided with the target patterns.

Referring to FIG. 1, in some embodiments of the present application, the release paper 1 includes a base paper layer 12, and the release layer 11 is provided on a surface of the base paper layer 12. It will be appreciated that a specific process of forming the release layer 11 onto the base paper layer 12 belongs to the prior art and will not be described in detail herein.

Referring to FIGS. 1, 7 and 8, in some embodiments of the present application, a surface of the base paper layer 12 not provided with the release layer 11 is provided with the target pattern. Specifically, a surface of the target paper with double target pattern surfaces according to the present disclosure provided with the adhesive paper 2 may be referred to as a front surface, and a surface not provided with the adhesive paper 2 may be referred to as a back surface. In some embodiments of the present application, the target pattern provided on the release paper 1 is arranged on the back surface.

Referring to FIG. 1, in some embodiments of the present application, a surface of the base paper layer 12 provided with the release layer 11 is provided with the target pattern. Specifically, a surface of the target paper with double target pattern surfaces according to the present disclosure provided with the adhesive paper 2 may be referred to as a front surface, and a surface not provided with the adhesive paper 2 may be referred to as a back surface. In some embodiments of the present application, the target pattern provided on the release paper 1 is arranged on the front surface; that is, on the surface provided with the adhesive paper 2, wherein, when the adhesive paper 2 is torn off, the target pattern originally hidden under the adhesive paper 2 can be exposed.

Referring to FIG. 1, in some embodiments of the present application, the release layer 11 is a transparent layer to reveal the target pattern provided on the base paper layer 12. It will be appreciated that a process of printing or otherwise applying the target pattern to the base paper layer 12 belongs to the prior art and is not limited herein.

Referring to FIG. 1, in some embodiments of the present application, the release layer 11 is a colored layer to constitute the target pattern. It will be understood that a process of “making the release layer 11 to be colored and have a colored figure or colored pattern” belongs to the prior art and is not limited herein.

It should be noted that the “color” and the “colored layer” in the specification of the present disclosure are described in contrast to colorless and transparent characteristics, and for example, the “color” and the “colored layer” may be/have various colors, such as red, yellow, green, blue, purple, orange, black, gray, pink, or the like.

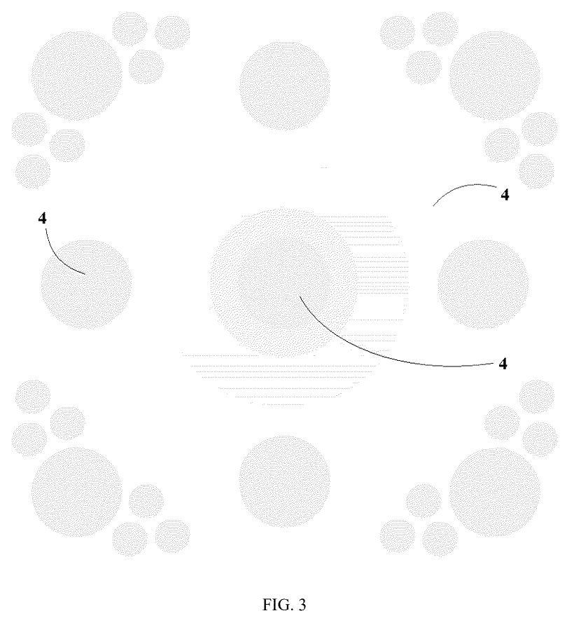

Referring to FIGS. 3 to 6, in some embodiments of the present application, the target pattern each includes at least two chromatic zones 4, and the chromatic zones 4 have a same color type and different chrominances. It will be appreciated that the chromatic zones 4 with different chrominances on the target pattern may facilitate the user to confirm a shooting record after shooting.

Referring to FIGS. 3 to 6, in some embodiments of the present application, the target paper has a target center, and the target pattern has a color chrominance gradually darkening or gradually lightening in a direction away from the target center. It will be appreciated that regions with different chrominances on the target pattern may facilitate the user to confirm a shooting record after shooting.

Referring to FIGS. 3 to 6, in some embodiments of the present application, various regions of the respective target pattern have different printing densities of pigment dots. It should be noted that one way of regulating the chrominance distinction is control over the respective printing density of the pigment dots as described above, wherein the printing density is set to be larger for a region with a darker chrominance requirement, and the printing density is set to be smaller for a region with a lighter chrominance requirement. Certainly, in other embodiments of the present application, other means may be adopted to regulate the chrominance distinction of the respective regions on the target pattern, which is not strictly limited herein.

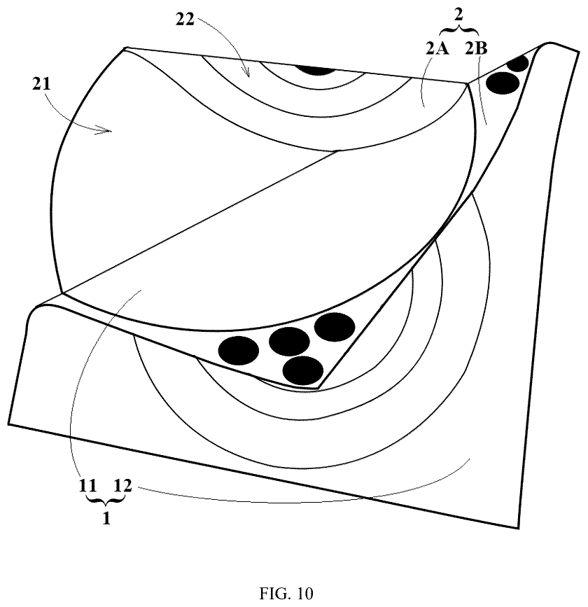

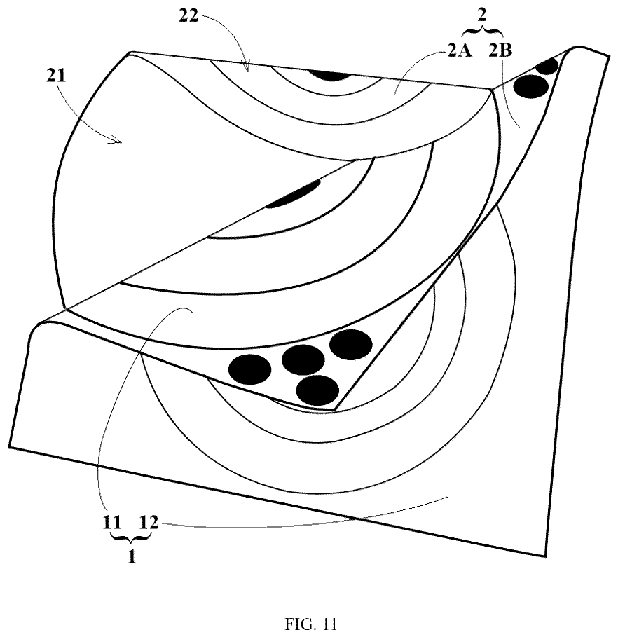

Referring to FIGS. 7 and 8, in some embodiments of the present application, the target paper has at least two adhesive papers 2, wherein one of the adhesive papers serves as a main target sticker, the other adhesive papers 2 serve as auxiliary target stickers, and at least one of the auxiliary target stickers is provided with the target pattern.

It should be noted that in some embodiments of the present application, referring to FIG. 3, the target pattern includes various target regions and target circle contour lines for distinguishing the target regions.

In some embodiments of the present application, the target pattern has a main target center 31.

In some embodiments of the present application, the target pattern further includes a plurality of auxiliary target centers 32, and the plurality of auxiliary target centers 32 are arranged around the main target center 31.

Referring to FIG. 1 which shows a target paper according to a specific embodiment of the present application, the target paper includes a release paper 1 and an adhesive paper 2 stuck on a release layer 11 of the release paper 1, and the release layer 11 of the release paper 1 is provided on a base paper layer 12. In use, the adhesive paper 2 is torn from the release layer 11, and then, the adhesive paper 2 with the target pattern is stuck to a support structure, such as a wood pile, such that the user can shoot the adhesive paper 2; the remaining release paper 1 with the target pattern can also be hung, nailed or stuck on a support structure, such as a wood pile, for the user to shoot.

Referring to FIG. 2 which shows a target pattern on a target paper according to a specific embodiment of the present application, the target pattern may be specifically provided on the adhesive paper 2 or any surface of the release paper 1, i.e., a surface of the release paper 1 provided with the release layer 11 or a surface of the base paper layer 12 of the release paper 1 opposite to the release layer 11. Specifically, referring to FIG. 2, the target pattern may have a plurality of targeting centers, such as a main target center 31 located at a midpoint of the target pattern and a plurality of auxiliary target centers 32 distributed around an outer periphery of the main target center 31; each of the main target center 31 and the auxiliary target center(s) 32 may be obtained by drawing by a plurality of concentric circular contour lines. It should be noted that design concepts, such as a specific form, color, or the like, of the target pattern of the target paper according to the present disclosure can be selected and adjusted according to practical application requirements, and are not strictly limited herein.

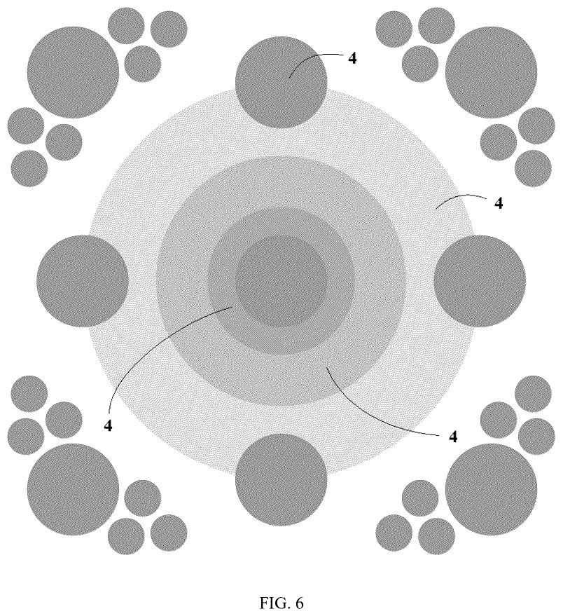

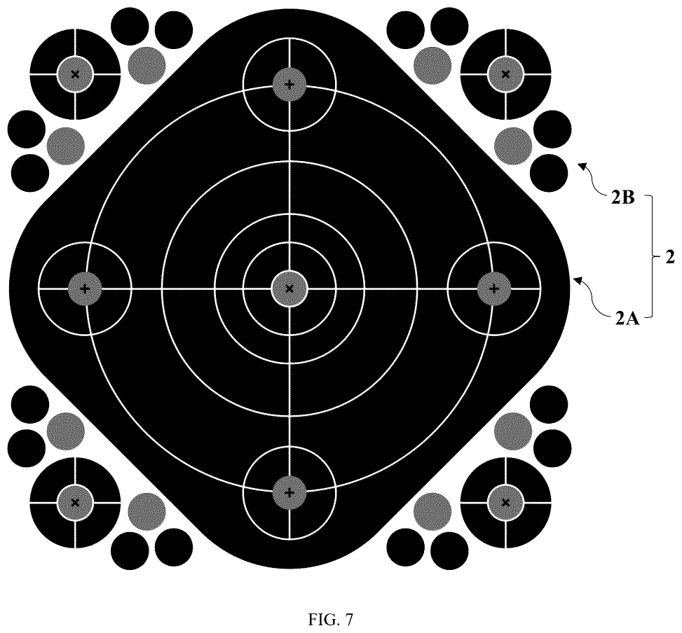

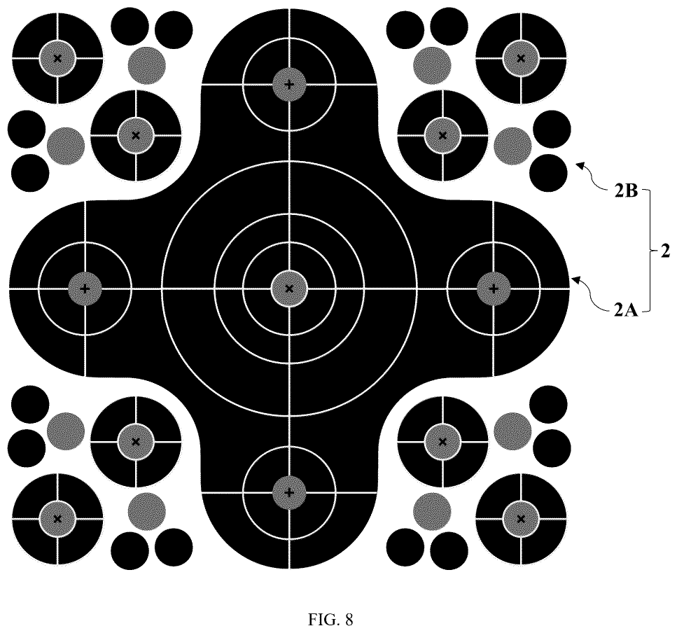

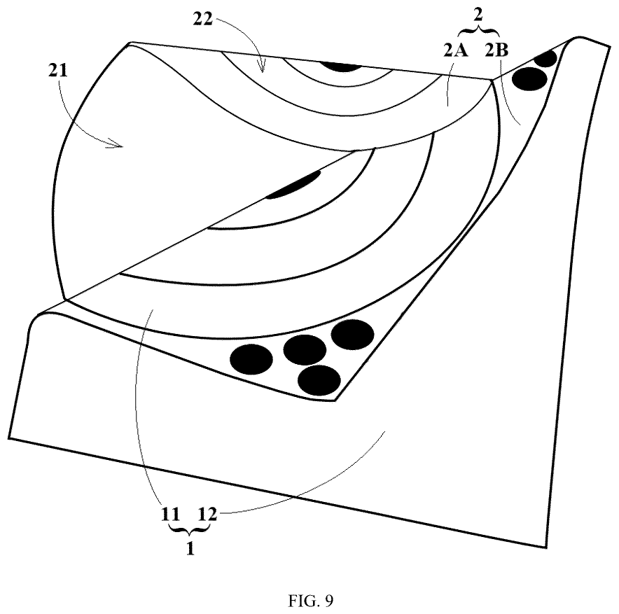

Referring to FIGS. 3 and 6 which are schematic diagrams of chromatic zones 4 of a target paper according to two specific embodiments of the present application, it can be seen that the chromatic zones are formed by a plurality of circular patterns with different chrominances, wherein some circular patterns with different gray scales are combined and spread out in a concentric circle arrangement, and the other circular patterns are distributed around the foregoing circular patterns.

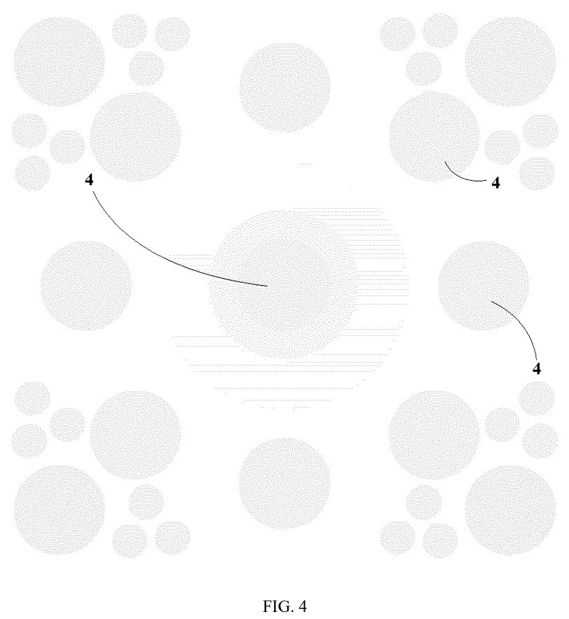

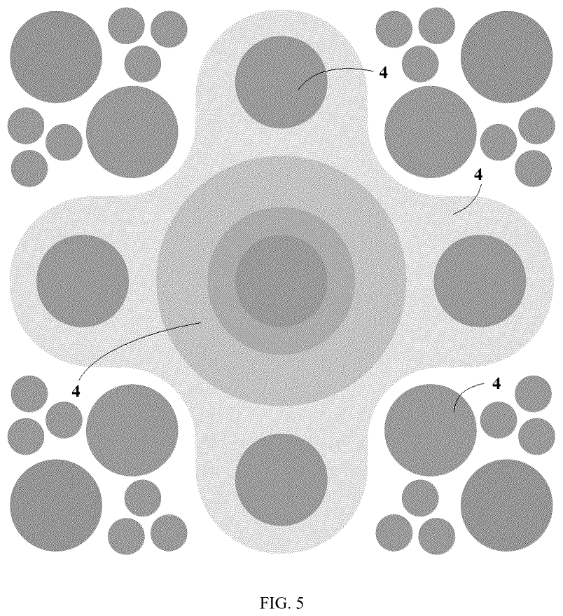

Referring to FIGS. 4 and 5 which are schematic diagrams of chromatic zones 4 of a target paper according to two specific embodiments of the present application, it can be seen that the chromatic zones are formed by a plurality of circular patterns with different chrominances, wherein some circular patterns with different gray scales are combined and spread out in a concentric circle manner, and the other circular patterns are distributed around the foregoing circular patterns; and wherein, outer contours of some chromatic zones 4 are approximately in a cross shape, and the cross shape can give place to the auxiliary target sticker, so as to fully utilize limited space and materials on each target paper; meanwhile, the auxiliary target sticker and the main target sticker are both in the form of the adhesive paper 2, but the two adhesive papers 2 are in independent split design, and in use, the adhesive paper 2 as the main target sticker can be torn off and stuck onto a fixing frame, such as a wood pile, for shooting, and the auxiliary target sticker can be stuck onto a damaged region of the main target sticker after the main target sticker is shot, such that the main target sticker can be further shot, and thus the purpose of fully utilizing resources is achieved; the auxiliary target sticker can also be used as a common sticker, to stick the main target sticker or the release paper 1 with the target pattern to a fixing frame, such as a wood pile, to play a fixing role for the user to shoot.

Referring to FIG. 7 which is a schematic diagram of a target pattern of a target paper according to a specific embodiment of the present application, a general contour of the main target sticker has a square shape with round corners, which is different from a circular contour in the prior art, wherein the round-corner square main target sticker design can make partial space and reduce materials so as to accommodate the auxiliary target sticker.

Referring to FIG. 8 which is a schematic diagram of a target pattern of a target paper according to a specific embodiment of the present application, a general contour of the main target sticker has a cross shape, which is different from a circular contour in the prior art, wherein the cross-shaped main target sticker design can make partial space and reduce materials so as to accommodate the auxiliary target sticker.

It should be noted that “a plurality of” in the specification of the present disclosure means two or more, and may be, for example, three, four, five, six or more.

It should be noted that the “target pattern” described in the specification of the present disclosure includes, but is not limited to, various figures and patterns available for shooting in the prior art, such as a targeting pattern composed of a plurality of concentric circles, and such as an animal, a fruit, a can or a wine bottle, and the animal may include common prey in shooting sports, such as a marmot, a fox, a wolf, a turkey, or the like.

The foregoing descriptions are merely specific embodiments of the application, but are not intended to limit the protection scope of the present application. Any variation or replacement readily figured out by a person skilled in the art within the technical extent revealed in the present disclosed shall fall within the protection scope of the present application. Therefore, the protection scope of the present application shall be subject to the protection scope specified in the claims. Furthermore, the principle and the embodiment of the present application are illustrated by applying specific examples in the specification, the above description of the embodiments is only for assisting understanding of the method of the present disclosure and the core idea thereof, and the content of the specification should not be construed as limiting the present disclosure.

1. A target paper with double target pattern surfaces, comprising:
a release paper with one surface having a release layer; and
an adhesive paper stuck onto the release layer;
wherein the adhesive paper has a first target pattern on a surface of the adhesive paper opposite to the release layer of the release paper, and the release paper has a second target pattern on at least one of two surfaces of the release paper in a thickness direction;
wherein the adhesive paper is configured to be detached from a release paper and attached to a target for shooting;
wherein, after the adhesive paper is detached, the release per with the second target pattern is configured to directly serve as another target for shooting.

2. The target paper according to claim 1, wherein the release paper comprises a base paper layer, and the release layer is provided on a first surface of the base paper layer.

3. The target paper according to claim 2, wherein a second surface of the base paper layer not provided with the release layer is provided with the second target pattern.

4. The target paper according to claim 3, wherein each of the first and second target patterns comprises at least two chromatic zones, and the chromatic zones have a same color type and different chrominances.

5. (canceled)

6. The target paper according to claim 3, wherein each of the first and second target patterns have a main target center.

7. The target paper according to claim 6, wherein each of the first and second target patterns further comprise a plurality of auxiliary target centers, and the plurality of auxiliary target centers are arranged around the main target center.

8. The target paper according to claim 2, wherein a surface of the the release layer on which the adhesive paper is stuck is provided with the second target pattern.

9. The target paper according to claim 8, wherein each of the first and second target patterns comprise at least two chromatic zones, and the chromatic zones have a same color type and different chrominances.

10. (canceled)

11. The target paper according to claim 8, wherein the each of the first and second target patterns have a main target center.

12. The target paper according to claim 11, wherein the each of the first and second target patterns further comprise a plurality of auxiliary target centers, and the plurality of auxiliary target centers are arranged around the main target center.

13. The target paper according to claim 8, wherein the release layer is a transparent layer to reveal the second target pattern provided on the base paper layer.

14. The target paper according to claim 8, wherein the release layer is a colored layer to constitute the second target pattern.

15. The target paper according to claim 1, wherein each of the first and second target patterns comprise at least two chromatic zones, and the chromatic zones have a same color type and different chrominances.

16. The target paper according to claim 1, wherein the each of the first and second target patterns have a target center a color chrominance gradually darkening or gradually lightening in a direction away from the target center.

17. The target paper according to claim 1, wherein various regions of each of the first and second target patterns have different printing densities of pigment dots.

18. (canceled)

19. The target paper according to claim 1, wherein each of the first and second target patterns have a main target center.

20. The target paper according to claim 19, wherein each of the first and second target patterns further comprise a plurality of auxiliary target centers, and the plurality of auxiliary target centers are arranged around the main target center.

21. The target paper according to claim 1, wherein the adhesive paper has two target sticker regions, wherein the two target sticker regions includes a main target sticker region having a main target sticker and an auxiliary target sticker region having a plurality of auxiliary target stickers.

22. The target paper according to claim 21, wherein the main target sticker has a cross-shaped contour, and the auxiliary target stickers are disposed in a space between two adjacent elongated extensions of the cross-shaped contour.

23. The target paper according to claim 21, wherein both the main target sticker and the auxiliary target stickers have at least one target center of the target pattern, and when the target center on the main target sticker has been damaged, the target center of the auxiliary target stickers is configured to be stuck onto a damaged region of the target center on the main target sticker.
